(19) United States
(12) Patent Application Publication
(10) Pub. No.: US 2017/0316768 A1
(43) Pub. Date: Nov. 2, 2017

(54) METHODS AND SYSTEMS FOR SYNCHRONIZING AN AUDIO CLIP EXTRACTED FROM AN ORIGINAL RECORDING WITH CORRESPONDING LYRICS

(71) Applicant: Line for Line, Inc., Los Angeles, CA (US)

(72) Inventor: Constantine Andriotis, Bayside, NY (US)

(21) Appl. No.: 15/582,045

(22) Filed: Apr. 28, 2017

Related U.S. Application Data
(60) Provisional application No. 62/328,966, filed on Apr. 28, 2016.

(51) Int. Cl. G10H 1/36; G06F 3/16

(52) U.S. Cl. CPC G10H 1/361; G06F 3/165; G10H 2220/091; G10H 2210/061; G10H 2240/325; G10H 2220/011

(57) ABSTRACT

Methods, systems, and devices for determining an audio portion based on a request received from a consumer or user of an operating device where the requests comprise a set of lyrics, then effect the streaming of the determined audio portion.

### CROSS-REFERENCE TO RELATED APPLICATIONS

This application claims priority to and benefit of Provisional Patent Application No. 62/328,966 filed Apr. 28, 2016, which is hereby incorporated by reference for all purposes.

### FIELD OF THE INVENTION

The invention relates to the field of synchronizing audio clips with lyrics of an associated audio recording.

### BACKGROUND

Currently, while listening to music there is no way to send precise portions of songs accompanied by the precise portions of song lyrics with speed and ease, while preserving context, and focusing attention on the intended moment of music.

### SUMMARY

An exemplary device may comprise a processor and memory, the device configured to: identify lyrics, via a user interface of a communication computing device, of a desired lyric phrase from within a pre-existing audio recording; determine a desired audio clip via extraction of an audio portion associated with the desired lyric phrase from the pre-existing recording; associate the lyrics with the audio clip based on a set of relevant information from a library of lyrics via a time-sync process; create a personalized message with associated sender identification, where the personalized message may comprise text and access to the desired audio clip; and transmit an electronic message to the electronic address of the recipient, where the electronic message may comprise the personalized message, the identified lyrics, and the determined desired audio clip.

Additionally, the device of claim 1 may be further configured to: receive a selection request for the audio clip; locate an audio content associated with the audio clip based on searching a data store for the appropriate audio clip; retrieve a list of audio content that is determined to be a match with the lyrics based on a synchronized audio and lyric component; and determine the audio content from the list of audio content based on the received request. Optionally, the processor and memory may perform the steps as a synchronous process, or the processor and memory may perform the steps as an asynchronous process.

In addition, the device may be further configured to: determine a corresponding text file for the determined desired audio clip, where the determined desired audio clip is stored in an audio file. In one embodiment, the determined desired audio clip may be retrieved from the audio file. In another embodiment, text in the text file may then be time-synced to the determined desired audio clip and stored in an audio and lyric synchronized file. Optionally, a secondary file may be created that comprises a portion of the audio and lyric synchronized file that corresponds to a selected text.

### BRIEF DESCRIPTION OF THE DRAWINGS

Embodiments may be illustrated by way of example and not limitation in the figures of the accompanying drawings, and in which:

FIG. 1 depicts an exemplary embodiment of a synchronized audio and lyric computing system;

FIG. 2 depicts an exemplary embodiment of a synchronized audio and lyric computing system;

FIG. 3 illustrates an exemplary top-level functional block diagram of a synchronized audio and lyric computing device embodiment;

FIG. 4 illustrates a flow chart of an exemplary method of implementation of a synchronized audio and lyric computing system; and

FIG. 5 depicts an exemplary flow chart of a method of performing the audio clip and lyric synchronizing by a mobile device.

### DETAILED DESCRIPTION

The present application discloses methods, devices, and systems for allowing a listener to select the words of a song and send an exact moment of music with lyrics and melody to any other user, at any time during the playback; and more particularly, to methods and devices for dynamically time-syncing lyrics with an audio clip, then transmitting the portion of the audio clip along with the lyrics associated with the audio clip.

In one embodiment of the present application, the system may combine the sharing of audio portions of songs with the ability to share lyrics, most commonly accomplished via texting/posting etc. This may be accomplished, for example, via memorization or the act of copying and pasting links of lyrics. Embodiments may capture and send a portion of a song via a precision-based synchronization method where a computing device isolates a portion of the audio file having the desired context. That is, a scheme for time stamping music and the associated lyrics may be implemented where the time stamping is performed with a high degree of accuracy, for example, to the tenths of a second. Accordingly, the selection process may be extremely precise.

In one embodiment, the lyrics (lines) may be “time stamped” so that the user is able to share the exact segment of music by selecting the lyrics that correspond with the appropriate “timed” portion of the song. This allows for precise “music messaging” and “lyrics sharing” with speed and ease. Once the Lyrical Music Message is sent, the recipient may then receive the precise portion of music and accompanying lyrics, as the sender intended it. Accordingly, the gap between audio and visual depiction of the audio may be bridged with speed, accuracy, and ease while preserving the context of the song and providing the recipient with a clear “Lyrical Music Message.”

Multimedia services are generally services that handle several types of media, such as audio and video in a typically synchronized way from the user's point of view. A multimedia service may involve multiple parties, multiple connections, and the addition or deletion of resources and users within a single communication session. A synced audio file and associated lyrics may be transmitted in a unidirectional point-to-multipoint service, in which data may be transmitted from a single source to multiple devices in the associated broadcast service area. In one embodiment, a broadcast service may be construed as a push-type service, where the audio file and lyrics may be pushed to other device or devices.

In this embodiment, a user may have constant access to lyrics (lines) and will be able to select and share an exact portion of “lyrical music” at any time. The lyrics will be “time stamped” so that the user is able to share the exact segment of music based on the lyrics that correspond with the appropriate “timed” portion of the song. An exemplary JavaScript Object Notation may be utilized to capture (user/lyric/name/title/pic/url) for effective data-interchange between users. Once the “Lyrical Music Message” is sent, the recipient will then receive the precise portion of music and accompanying lyrics. This allows for precise “music messaging” with “lyrics sharing.”

The system and method embodiments may provide a computing device, having a processor and memory, for locating specific audio content, i.e., audio portion. The method may include receiving a selection request for the audio content and then searching a data store for the appropriate audio portion based on the request. The system may then retrieve a list of audio content that is determined to be a match with the lyrics based on a synchronized audio and lyric component. Once a selection of the audio content is made, a computer file, e.g., a resource for storing information, may be retrieved. A synchronous or asynchronous or combinations thereof, computing may use the corresponding text file for the original audio content file to retrieve a audio and lyric synchronized file. The text in the text file may then be time-synced to the original audio file and the corresponding text file. In some embodiments, a secondary file may be created that comprises a portion of the original audio/visual content file that corresponds to the selected text. Accordingly, the start and stop times of the audio content, i.e., audio portion, in the original audio file corresponding to the desired lyrics may then be marked.

Exemplary embodiments of the synchronized audio and lyric system may stream the synced file from a remote location that may comprise a recipient device comprising an operating system and a data store, an operator device comprising an operating system and a data store, and a computing device comprising an operating system and a data store. The system effects the streaming of the audio portion based on a request received from a consumer or user of the operating device. The devices may comprise an application program running on the operating system to process streaming of audio that may have been synchronized with lyrics. That is, the operator device may then communicate the video and audio stream along with a set of associated information to the recipient device which will then be able to listen to the audio synced with the lyrics.

The operator device may transmit the audio and associated information to the recipient device via the server computing device and via, for example, wireless WiFi®, wireless local area network (WLAN), or other wireless networks with broadcast methods such as Long Term Evolution (LTE), Bluetooth, and/or any other hardware or software radio broadcast methods. The server computing device may connect and work with any such devices that may use LTE or WLAN, for example, mobile phones, specifically smartphones, personal computers, video game consoles, tablets, televisions, and/or digital cameras, to connect to a network resource such as the Internet via wired or wireless communication.

A system of communicating between a sender and a recipient to transmit synchronized audio and lyrics may perform the following steps—not necessarily in this order—to transmit an audio portion associated with a set of lyrics by: (a) identify lyrics, via the user interface of a communication computing device, of a desired lyric phrase from within a pre-existing audio recording; (b) extracting an audio portion associated with the desired lyric phrase from the pre-existing recording into a desired audio clip; (c) associating the lyrics with the audio clip via either inputting text via the user interface or utilizing an automatic process of gathering the relevant information from a library of lyrics; (d) creating the personalized message with the sender identification, the personalized text and access to the desired audio clip; (e) sending an electronic message to the electronic address of the recipient, where the electronic message may be any form of an SMS/EMS/MMS message, instant message, or email message including a link to the personalized message or an EMS/MMS or email message including the personalized message.

The computing device, or server, that is configured to execute these steps may be a link processing component that links the audio data and the lyric data—that may have been acquired by a data acquiring component—with each other. If the relevant information data is not present, the link processing component may query a separate component, for example, a data acquiring component, to acquire the corresponding data and store it in a storage component so as to link the audio data with the lyric data. Some embodiments may support a replay processing unit to replay the music data, that is a synchronous display unit may read the corresponding lyric data and display the lyrics in accordance with the progression of replay.

In another embodiment, the system may optionally allow users to post or publish audio information to a destination on a digital network. The audio clip may be sent directly to another user's device or may be published or uploaded to a network site, web page, user group or other location. A user interface allows organizing, reviewing, editing, tagging, transferring, and other types of processing or manipulation in association with the audio portion to be transferred, or which has been received. Accordingly, lyrics may be provided along with audio clips that may be streaming live. A live stream may be accessed which includes time-syncing information for a song. Lyrics and/or other textual information such as song title, song artist, and album title may also be accessed. A lyric file may be accessed that includes further timing information. The timing information is used to synchronize the song lyrics and live stream.

A specific method for performing the audio clip and lyric synchronizing may be by a mobile device user interface that may include connecting to a network, selecting song lyrics to be downloaded to a mobile device user interface, storing the downloaded song lyrics in the mobile device user interface; and simultaneously transmitting a stored song while displaying the downloaded song lyrics on the mobile device user interface. As such, the method may also include downloading and displaying lyrics in synchronization with an audio clip being played in real-time whereby the user may then transmit that audio clip and associated lyrics to another user.

In one embodiment, the data communication between a user and other recipients may use multi-cast audio/video and other relevant information, for example, using a User Datagram Protocol (UDP) which is a transport layer protocol defined for use with the IP network layer protocol. The data communication may further use time-slice individual data. In some embodiments, a synchronization component of the computing device may be configured to: (1) select an audio file, (2) determine a specified audio portion of the audio file for syncing, and (3) time-synchronize the determined audio portion with a set of corresponding lyrics. In one exemplary embodiment, a push data mechanism may be implemented via TCP/IP protocols and the time sync updates may be for time-slice control. Each mobile device may comprise an embedded web application server that may allow executable applications or scripts, e.g., application software, that may be available in versions for different platforms and are to be executed on the mobile device. Applications may be developed to support various mobile devices and their respective operating systems such as: iOS, Android, and Windows. In some embodiments, the application may include a capability to compress the audio clip portion. The audio clip may then be compressed data, requiring the receiving application to decompress and then playback the audio clip portion. The application may also spool the audio so that the user may have control of the audio and to rewind, fast forward, and pause. Optionally, interactive features for social media such as Twitter and Facebook may be provided.

Several exemplary implementations of the methods and systems for synchronizing an audio clip that is extracted from an original recording, with a corresponding lyrics, may be represented as follows:

### First Exemplary Embodiment

Lyrical Music Messaging while Listening

Downloading Step:
1—User Downloads the “Lyrical Music Messenger” Software Application
2—User is prompted to enter their mobile number
   At this point a third party service system collects particular data points (i.e. MEIN #) followed by an SMS validation message
3—User then receives and enters an SMS validation code verifying the necessary data points
4—User is now validated and recognized by his/her mobile number
5—The user's music library (AC3 files) are verified and accessed
6—The user's contact book is also validated verifying who has also downloaded the mobile app and has been validated
***At this point the user now has full access to the Lyrical Music Messenger. Whether the user is listening to music or not he/she can begin the process of “Lyrical Music Messaging” by selecting lyrics. The lyrics are time stamped to coordinate with the timing of the actual audio version of the music. When a user selects and sends the set time stamped lyrics he/she is sending a “Lyrical Music Message”.
Sender (Listening)
7—The user selects a song and begins listening while the system retrieves the timestamped lyrics from a 3rd party API.
8—The user is now able to view the scrolling lyrics synchronized with the playing music
9—The user selects the lyrics via traditional text selection method (i.e. iOS text selection) with the cursor beginning the “Lyrical Music Message” at the time of the respective time stamped lyric
10—Once the user completes the selection a “Lyrical Music Message” is created
11—The user is then able to select contacts that are verified in the “Lyrical Music Messaging” network
12—User effectively interchange “Lyrical Music Messages” via JavaScript Object Notation which captures particular data points (i.e. user/lyric/name/title/pic/url).
Recipient (Lines)
Lyrical Music Message Opening—from Mailbox Module
1—User (recipient) effectively completes the “Lyrical Music Message” interchange via JavaScript Object Notation which retrieves the correct data points (i.e. user/lyric/name/title/pic/url)
2—The user then reads the “Lyrical Music Message” while listening to accompanying music
3—The user then has the opportunity to reply with a Lyrical Music Message and or buy/listen to the song depending on whether or not they do/do not own the song
***There are unique elements in the display of this message (interface)
***Interface is changing while the “Lyrical Music Message” is playing
***May enact a unique algorithm

### Second Exemplary Embodiment

Lyrical Music Messaging via Lyrics (no audio)

Downloading
1—User Downloads the “Lyrical Music Messenger” Software Application
2—User is prompted to enter their mobile number
At this point a third party service system collects particular data points (i.e. MEIN#) followed by an SMS validation message
3—User then receives and enters an SMS validation code verifying the necessary data points
4—User is now validated and recognized by his/her mobile number
5—The user's music library (AC3 files) are verified and accessed
6—The user's contact book is also validated verifying who has also downloaded the mobile app and has been validated
At this point, the user now has full access to the Lyrical Music Messenger. Whether the user is listening to music or not he/she can begin the process of “Lyrical Music Messaging” by selecting lyrics. The lyrics are time stamped to coordinate with the timing of the actual audio version of the music. When a user selects and sends the set time stamped lyrics he/she is sending a “Lyrical Music Message”.
Sender (Lyrics)
7—The user access a song's lyrics and the system retrieves the timestamped lyrics from a 3rd party API.
8—The user is now able to view the lyrics synchronized with the music
9—The user selects the lyrics via traditional text selection method (i.e. iOS text selection) with the cursor beginning the “Lyrical Music Message” at the time of the respective time stamped lyric
10—Once the user completes the selection a “Lyrical Music Message” is created
11—The user is then able to select contacts that are verified in the “Lyrical Music Messaging” network
12—User effectively interchange “Lyrical Music Messages” via JavaScript Object Notation which captures particular data points (i.e. user/lyric/name/title/pic/url).
Recipient (Lines)
Lyrical Music Message Opening—from Mailbox Module
1—User (recipient) effectively completes the “Lyrical Music Message” interchange via JavaScript Object Notation which retrieves the correct data points (i.e. user/lyric/name/title/pic/url)
2—The user then reads the “Lyrical Music Message” while listening to accompanying music
3—The user then has the opportunity to reply with a Lyrical Music Message and/or buy listen to the song depending on whether or not they do/do not own the song
***There are unique elements in the display of this message (interface)
***Interface is changing while the “Lyrical Music Message” is playing
***May enact a unique algorithm

### Third Exemplary Embodiment

User w/o the App Receives SMS message stating user “X” has sent a “Lyrical Music Message” w/ a link to download the app to receive the message Downloading
1—User Downloads the “Lyrical Music Messenger” Software Application
2—User is prompted to enter their mobile number
***At this point a third party service system collects particular data points (i.e. MEIN#} followed by an SMS validation message
3—User then receives and enters an SMS validation code verifying the necessary data points
4—User is now validated and recognized by his/her mobile number
5—The user's music library (AC3 files) are verified and accessed
6—The user's contact book is also validated verifying who has also downloaded the mobile app and has been validated
At this point, the user now has full access to the Lyrical Music Messenger. Whether the user is listening to music or not he/she can begin the process of “Lyrical Music Messaging” by selecting lyrics. In this flow, the user will be opening the “Lyrical Music Message” from “The Lines” mailbox. The lyrics are time stamped to coordinate with the timing of the actual audio version of the music. When a user selects and sends the set time stamped lyrics he/she is sending a “Lyrical Music Message”.
Sender (Reply)
User w/ App Downloaded Lyrical Music Message Opening—from Mailbox Module
7—User (recipient) effectively completes the “Lyrical Music Message” interchange via JavaScript Object Notation which retrieves the correct data points (i.e. user/lyric/name/title/pic/url)
8—The user then reads the “Lyrical Music Message” while listening to accompanying music
9—The user then has the opportunity to reply with a Lyrical Music Message and/or buy/listen to the song depending on whether or not they do/do not own the song
***There are unique elements in the display of this message (interface)
***Interface is changing while the “Lyrical Music Message” is playing
***May enact a unique algorithm
Lyrical Music Messaging via Lyrics (no audio)
10—The user access a song's lyrics and the system retrieves the timestamped lyrics from a 3rd party API.
11—The user is now able to view the lyrics synchronized with the music
12—The user selects the lyrics via traditional text selection method (i.e. iOS text selection) with the cursor beginning the “Lyrical Music Message” at the time of the respective time stamped lyric
13—Once the user completes the selection a “Lyrical Music Message” is created
14—The user is then able to select contacts that are verified in the “Lyrical Music Messaging” network
15—User effectively interchange “Lyrical Music Messages” via JavaScript Object Notation which captures particular data points (i.e. user/lyric/name/title/pic/url).
Recipient (Lines}
Lyrical Music Message Opening—from Mailbox Module
16—User (recipient) effectively completes the “Lyrical Music Message” interchange via JavaScript Object Notation which retrieves the correct data points (i.e. user/lyric/name/title/pic/url)
17—The user then reads the “Lyrical Music Message” while listening to accompanying music
18—The user then has the opportunity to reply with a Lyrical Music Message and/or buy/listen to the song depending on whether or not they do/do not own the song
***There are unique elements in the display of this message (interface)
***Interface is changing while the “Lyrical Music Message” is playing
***May enact a unique algorithm

Embodiments include a scheme where a user may send a message to someone who does not have the app installed or running on their mobile phone and that person then receives a prompt, via for example SMS message, with a link to download the app from the appropriate app store. Once that person has downloaded the app, and launches the app, they may then open the message (“Lines” mailbox).

Other embodiments enable users to send timed text (i.e., set of lyrics) messages by applying a specific duration of time to a clause or “phrase” of words, thereby determining the rate at which the lyrics will appear when the recipient opens the message. This text (set of lyrics) may then be sent from a sender to a recipient. Accordingly, the phrase will then appear to the recipient at the specific duration set by the sender.

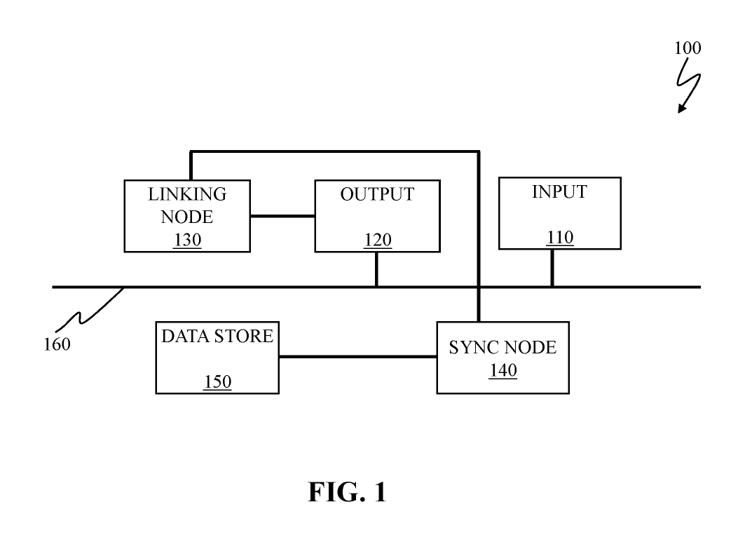

FIG. 1 depicts an exemplary embodiment of a synchronized audio and lyric computing system 100 comprising a first connection point, e.g., a node for input traffic 110, and a second connection point, e.g., a node for output traffic 120. In some embodiments, a network node may be an active electronic device attached to a network environment, capable of sending, receiving, and/or forwarding information over a communication channel 160. For example, a communication channel may be established, via a communicative association, between a first device and a second device. In this example, a communication channel between the devices may, for example, facilitate the sharing of information data. Optionally, communication channels may be in the form of physical transmission medium, i.e., a wired communication channel; logical connection over a multiplexed medium, i.e., a radio communication channel or encapsulated packet payload or over virtual private network (VPN); and/or non-physical transmission medium, i.e., a dedicated wireless communication channel. The information data being transmitted may be received from a source, for example, the internet, where the synchronized audio and lyric computing system 100 may then act as a synchronizer for the received data, i.e., packets. In one embodiment, a synchronization node 140 may determine an exact matching of audio with associated lyric, where the determination may be based on a set of rules. The synchronization node 140 may further communicate with a data store 150, e.g., a database, where the database may store the audio files and corresponding lyrics. In one embodiment, the synchronization node 140 may determine the lyrics based on a received time interval from the user. The determination of whether a match exists may be done via a device kernel and network stack, and may be indicated by a flag. Additionally, an optional linking node 130 may be present in the synchronized audio and lyric computing system 100 so that the synchronization node 140 may then communicate the determined results to the linking node 130 which may then link the set of packets with each other. It may well be understood that in a computer networked environment comprising a plurality of networked processing nodes, a first computing device may host a virtual network computing server that may be connected to a second computing device which may host a virtual network computing server. The networked environment may be a collection of client and server nodes in that network.

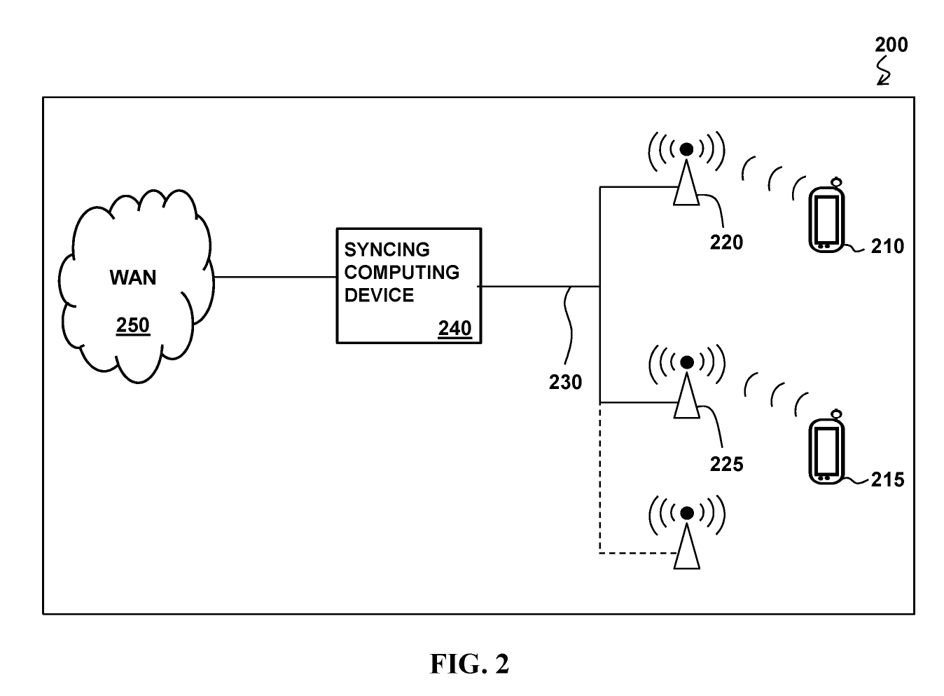

FIG. 2 depicts an exemplary embodiment of a synchronized audio and lyric computing system 200 that includes a set of mobile devices 210,215, a plurality of WLAN devices 220,225, a syncing computing device 240, and a WAN 250 that may provide access to the Internet, where the syncing computing device 240 may act as the server and the mobile devices 210,215 may be operably connected to the syncing computing device 240 and the WAN 250. The mobile devices 210,215 may be used as a client for sending precise portions of songs accompanied by the precise portions of song lyrics. In one embodiment, the mobile devices 210,215 may be in communication with the syncing computing device 240 via an API communication medium. In some embodiments, network connection and support equipment may integrate the system with a Local Area Network (LAN). Optionally, a hypertext transfer protocol (HTTP) may be used in establishing a connection and, for example, an HTTP request and an optional HTTP response, may be used to establish the connection. In yet another embodiment, the syncing computing device 240 may execute a set of one or more applications via an operating system (OS) that may be running on the device.

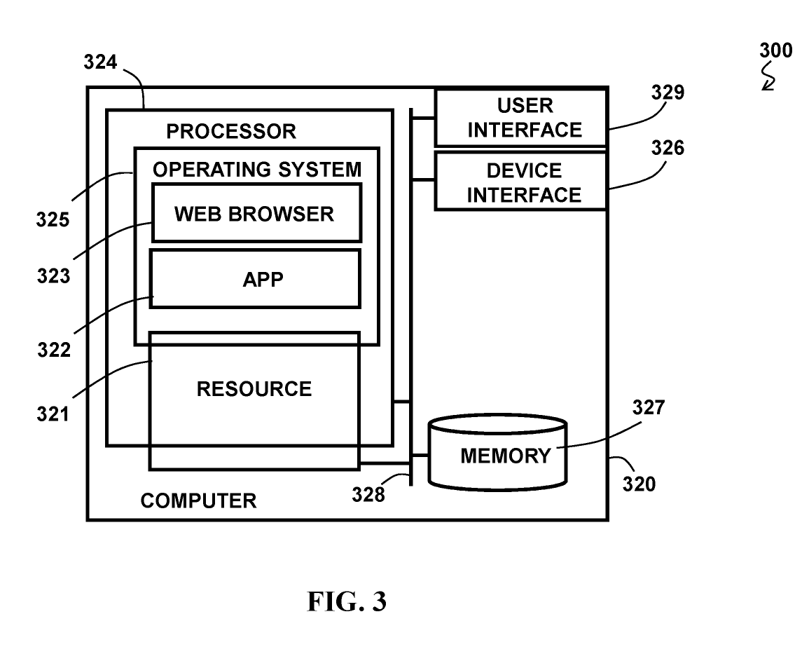

FIG. 3 illustrates an exemplary top-level functional block diagram of a synchronized audio and lyric computing device embodiment. The exemplary operating environment is shown as a computing device 320 comprising a processor 324, such as a central processing unit (CPU), a storage, such as a lookup table 327, e.g., an array, an external device interface 326, e.g., an optional universal serial bus port and related processing, and/or an Ethernet port and related processing, an output device interface 323, e.g., a web browser, a receiver, e.g., antenna 330, and an optional user interface 329, e.g., an array of status lights and one or more toggle switches, and/or a display, and/or a keyboard and/or a pointer-mouse system and/or a touch screen. Optionally, the computing device may comprise an addressable memory where the addressable memory may, for example, be: flash memory, eprom, and/or a disk drive or other hard drive. These elements may be in communication with one another via a data bus 328, via an operating system 325 such as a real-time operating system and/or an operating system, supporting a web browser and applications, the processor 324 may be configured to execute steps of a process, e.g., executing a rule set, according to the exemplary embodiments described above. Embodiments depict an application (app) 322 running on the operating system.

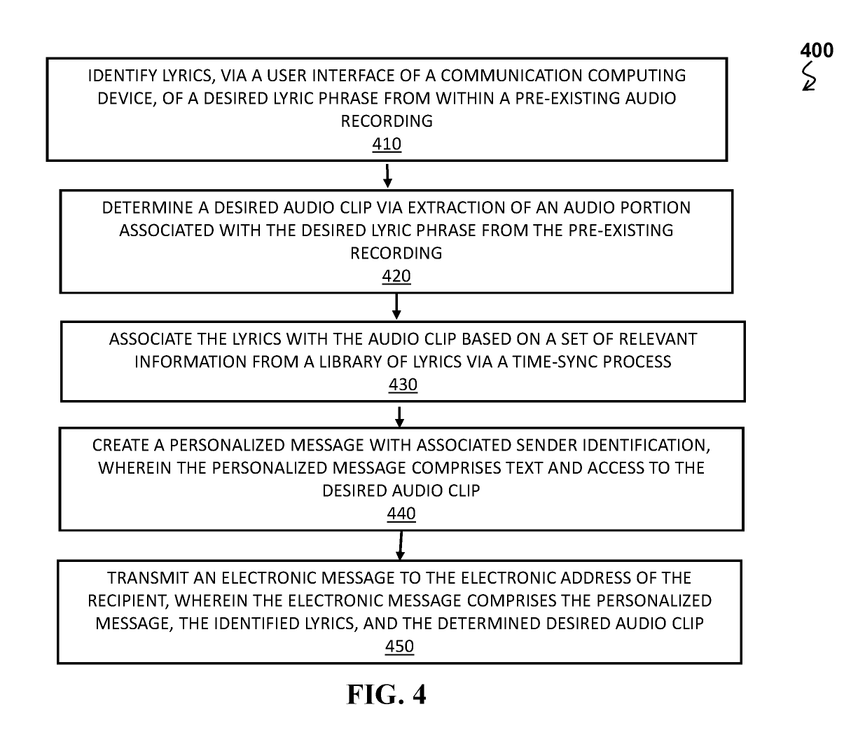

Embodiments may include an exemplary method of implementation of a synchronized audio and lyric computing system 400, as illustrated in a top-level flowchart of FIG. 4. The exemplary steps of the system and associated computing devices may comprise the following steps: (a) identify lyrics, via a user interface of a communication computing device, of a desired lyric phrase from within a pre-existing audio recording (step 410); (b) determine a desired audio clip via extraction of an audio portion associated with the desired lyric phrase from the pre-existing recording (step 420); (c) associate the lyrics with the audio clip based on a set of relevant information from a library of lyrics via a time-sync process (step 430); (d) create a personalized message with associated sender identification, wherein the personalized message comprises text and access to the desired audio clip (step 440); and (e) transmit an electronic message to the electronic address of the recipient, wherein the electronic message comprises the personalized message, the identified lyrics, and the determined desired audio clip (step 450).

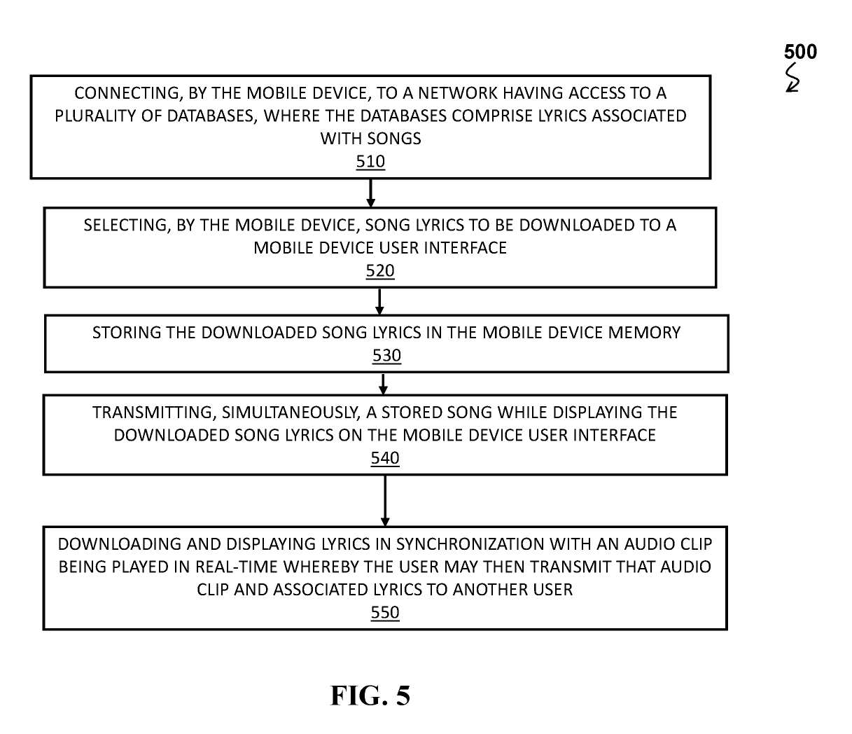

FIG. 5 depicts an exemplary method of performing the audio clip and lyric synchronizing 500 by a mobile device having a processor, addressable memory, and user interface. The method may include the steps of: connecting, by the mobile device, to a network having access to a plurality of databases, where the databases comprise lyrics associated with songs (step 510); selecting, by the mobile device, song lyrics to be downloaded to a mobile device user interface (step 520); storing the downloaded song lyrics in the mobile device memory (step 530); and simultaneously transmitting a stored song while displaying the downloaded song lyrics on the mobile device user interface (540). As such, the method may also optionally include downloading and displaying lyrics in synchronization with an audio clip being played in real-time whereby the user may then transmit that audio clip and associated lyrics to another user (step 550).

In one embodiment, the lyrics selection method—that also selects the corresponding audio—may be accomplished by a system of time stamping. That is, the lyrics may be manually time stamped and then stored in a database to be pulled or retrieved from. Accordingly, users may upload their audio and their lyrics and then are able to time stamp their own lyrics via the use of the messaging tool.

In another embodiment, the lines of lyrics and audio may first be synchronized. Then the lines of lyrics are saved with the corresponding timestamps of audio (specify the lines are timed—not the individual words). After that, the users may choose specific sections of lines of the songs by selecting specific lines of lyrics. This scheme would be in addition to a user simply selecting lyrics and then the audio being found and synchronized.

Embodiments have been described with reference to flowchart illustrations and/or block diagrams of methods, apparatus (systems) and computer program products according to embodiments. Each block of such illustrations/diagrams, or combinations thereof, can be implemented by computer program instructions. The computer program instructions when provided to a processor produce a machine, such that the instructions, which execute via the processor, create means for implementing the functions/operations specified in the flowchart and/or block diagram. Each block in the flowchart/block diagrams may represent a hardware and/or software module or logic, implementing embodiments. In alternative implementations, the functions noted in the blocks may occur out of the order noted in the figures, concurrently, etc.

Computer programs (i.e., computer control logic) are stored in main memory and/or secondary memory. Computer programs may also be received via a communications interface. Such computer programs, when executed, enable the computer system to perform the features of the embodiments as discussed herein. In particular, the computer programs, when executed, enable the processor and/or multi-core processor to perform the features of the computer system. Such computer programs represent controllers of the computer system.

The visual displays in the figures are generated by modules in local applications on computing devices and/or on the system/platform, and displayed on electronic displays of computing devices for user interaction and form graphical user interface for interaction with the system/platform disclosed herein.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The illustrations and examples provided herein are for explanatory purposes and are not intended to limit the scope of the appended claims. This disclosure is to be considered an exemplification of the principles of the invention and is not intended to limit the spirit and scope of the invention and/or claims of the embodiment illustrated. It is contemplated that various combinations and/or sub-combinations of the specific features, systems, methods, and aspects of the above embodiments may be made and still fall within the scope of the invention. Accordingly, it should be understood that various features and aspects of the disclosed embodiments may be combined with or substituted for one another in order to form varying modes of the disclosed invention. Further it is intended that the scope of the present invention herein disclosed by way of examples should not be limited by the particular disclosed embodiments described above.

What is claimed is:

1. A device comprising a processor and memory, the device configured to:
identify lyrics, via a user interface of a communication computing device, of a desired lyric phrase from within a pre-existing audio recording;
determine a desired audio clip via extraction of an audio portion associated with the desired lyric phrase from the pre-existing recording;
associate the lyrics with the audio clip based on a set of relevant information from a library of lyrics via a time-sync process;
create a personalized message with associated sender identification, wherein the personalized message comprises text and access to the desired audio clip; and
transmit an electronic message to the electronic address of the recipient, wherein the electronic message comprises the personalized message, the identified lyrics, and the determined desired audio clip.

2. The device of claim 1, further configured to:
receive a selection request for the audio clip;
locate an audio content associated with the audio clip based on searching a data store for the appropriate audio clip;
retrieve a list of audio content that is determined to be a match with the lyrics based on a synchronized audio and lyric component; and
determine the audio content from the list of audio content based on the received request.

3. The device of claim 1, wherein the processor and memory may perform the steps as a synchronous process.

4. The device of claim 1, wherein the processor and memory may perform the steps as an asynchronous process.

5. The device of claim 1, further configured to:
determine a corresponding text file for the determined desired audio clip, wherein the determined desired audio clip is stored in an audio file.

6. The device of claim 5, wherein the determined desired audio clip is retrieved from the audio file.

7. The device of claim 6, wherein text in the text file is then time-synced to the determined desired audio clip and stored in an audio and lyric synchronized file.

8. The device of claim 7, wherein a secondary file is created that comprises a portion of the audio and lyric synchronized file that corresponds to a selected text.
